(19) United States
(12) Patent Application Publication
(10) Pub. No.: US 2013/0163250 A1
(43) Pub. Date: Jun. 27, 2013

(54) DECORATIVE LAMP ASSEMBLY AND LIGHT STRINGS INCLUDING A LAMP ASSEMBLY

(71) Applicant: Johnny Chen, Taipei (TW)

(72) Inventor: Johnny Chen, Taipei (TW)

(21) Appl. No.: 13/336,868

(22) Filed: Dec. 23, 2011

(51) Int. Cl. F21S 4/00; H01R 43/01; H01R 43/20; F21V 5/04

(52) U.S. Cl. 362/249.06; 362/311.02; 29/855

(57) ABSTRACT

An LED lamp assembly, including a generally cylindrical socket housing and a socket insert receivable into the socket housing and keyed to the socket housing to be receivable into the housing in a selected orientation. A two conductor wire having two insulated conductors surrounded by insulation is engaged over the socket insert on two sides and a top of the socket insert and interposed between the socket insert and an interior of the socket housing and extends out of a bottom of the socket housing. An LED lamp including a base, a lens and two wire piercing conductors is positioned in the socket housing such that each of the two wire piercing conductors pierce the insulation and engage one of the two insulated conductors.

### FIELD OF THE INVENTION

The present invention relates generally to light emitting diode lamps. More particularly, the present invention relates to light emitting diode lamps having housing and conductive structures to make consistent electrical contact with the conductor of a lamp wire.

### BACKGROUND OF THE INVENTION

Light emitting diode (LED) lamps provide a source of illumination for a variety of lighting applications including decorative lighting, automotive lighting, architectural lighting and other such applications. In particular, light emitting diodes are more commonly used in decorative Christmas light strings to reduce energy usage and provide pleasing color illumination. For those applications requiring that LED leads be coupled to an insulated conductor, such as in the context of decorative light strings such as those utilized for Christmas decoration, connecting the leads of conventional LED lead frames to wiring poses significant challenges. In some cases, in the prior art, leads are soldered directly to conductors to form a connection. In other circumstances, intermediate conductive structures such as wire terminals or mechanical connectors may be used to form an electrical connection. It can be difficult to make such connections. In particular, it can be difficult to make reliable connections that are consistently electrically and mechanically sound between the LED lead frame and the wiring. Poor connections can lead to lack of illumination, light failure, and can drive up the costs of manufacture and can potentially decrease the safety of the resulting lighting product.

### SUMMARY OF THE INVENTION

The present invention solves many of the above problems. An LED lamp assembly according to the invention generally includes a socket housing, a socket insert, an LED lamp, a cover and wire.

The socket insert is generally inserted into the socket housing via a top of the socket housing. The socket housing may be formed as a single piece unitary structure or may include two socket housing halves. According to an embodiment of the present invention, the socket insert can be inserted into the single piece socket housing from above or can be enclosed within the two socket housing halves of the two piece socket housing.

An LED lamp according to an embodiment of the invention includes piercing couplers extending downwardly therefrom that pierce the insulation of a two conductor wire that is held in place and overlies the socket insert thereby establishing a reliable electrical connection between the LED lamp and the conductors of the wire. Accordingly to one embodiment of the invention, an LED lamp may have a long lens extending upwardly to permit the appearance of the LED lamp assembly of the present invention to more closely resemble that of a conventional incandescent mini Christmas light. The LED lamp assembly of the invention may also include a cover. The cover may be molded of a translucent or transparent material and is insertable into the socket housing to cover the LED lamp to present a more traditional appearance to the LED lamp assembly of the present invention.

The socket insert according to an example embodiment of the present invention, presents a generally rectangular cube like structure that is keyed to fit inside the socket housing in only one orientation. The socket insert presents two grooves into which the wire may be received on the sides of the LED insert and a cavity on top of the LED insert into and over which the wire is also received. The cavity is bordered by four corner structures, two wire side walls, one indexed wall and one flat wall. The socket insert and socket housing can be formed of a non-conductive polymer material known to those skilled in the art.

The socket insert has an indexed side and an opposing non-indexed side and is indexed so as to be insertable into the socket housing in only one orientation. The socket insert is dimensioned to receive a two conductor wire so that the two conductor wire passes up a first side of the socket insert, across a top of the socket insert and down a second, opposing, side of the socket insert.

The socket housing presents a generally cylindrical body that has openings at a top and bottom thereof. The generally cylindrical body may be slightly tapered on the exterior walls thereof. The socket housing body presents external flats on opposing sides and prevents a roughly cylindrical interior cavity. The walls of the socket housing on the interior of the socket housing present an interior flat and an opposing index structure extending into the cavity. The interior walls also present interior steps at a bottom thereof. The steps includes a large step and an opposing small step. When viewed from below, the socket body has a wire receiving opening defined in a bottom thereof. The wire receiving opening, in one example embodiment, has a generally elongate shape having two opposing flat walls and two opposing arcuate walls. The top of the socket housing presents a generally circular opening.

The LED lamp assembly of the present invention is generally used with a two conductor wire including a first conductor, a second conductor and surrounding insulation that separates the two conductors. The conductors in one example embodiment are oriented generally parallel within the wire.

The cover of the LED lamp assembly is a generally transparent or translucent roughly cylindrical structure. The cover body presents a cylindrical portion, an upper conical portion and a knob portion. The cover body further presents a lower tapered portion separated from the cylindrical portion by an annular groove. The cover, according to one example embodiment of the invention, has generally the form and shape of a traditional incandescent mini light. This presents a traditional appearance to the LED lamp assembly of the invention. The cover also presents a generally cylindrical interior cavity and may be formed of a polymer material or can be formed of glass.

The LED lamp assembly according to one embodiment of the invention generally includes a lens, a base and an LED lead frame. According to one embodiment of the present invention, the LED chip is molded within the lens, while the LED lead frame is over molded with the surrounding base formed of a non-conductive polymer material. According to one embodiment of the present invention, the LED base, when viewed from above or below, presents an indexing flat on one side thereof while having a generally cylindrical structure.

The LED lead frame includes two piercing conductors extending downwardly therefrom. The two piercing conductors may be staggered so that each of the piercing couplers of the LED lead frame is positioned to engage one of the first and second conductors of the two conductor wire.

In one example embodiment, the piercing conductors include a fork like structure having a generally funnel shaped entrance and a wire receiving slot slightly smaller than the conductors of the two conductor wire into which the two conductor wire is received and engaged in a tight electrically conductive relationship.

The lens of the LED lamp may extend into the interior cavity of the cover when the LED lamp assembly is assembled or may extend only to the lower end of the interior cavity of the cover. Thus, the LED lamp may include a long lens or a short lens.

The lens may also include a tapered portion and a dome portion at a top thereof.

In another embodiment, the socket housing is generally cylindrical and receives a socket insert therein. The socket insert is inserted from the bottom of the housing and is engaged to the socket housing by the interaction of a circumferential groove and a circumferential insert ridge.

The socket housing is a generally cylindrical body presenting a circular opening at a first end and an elongate opening at a second end. Internally, the cylindrical body, optionally, presents a cylindrical wall surrounding a central opening in an annular wall therein. In the second embodiment, the wire and cover are similar to the embodiments described above.

### BRIEF DESCRIPTION OF THE DRAWINGS

FIG. 1 is a partially transparent perspective view of an LED lamp assembly according to an example embodiment of the invention;

FIG. 2 is an exploded perspective view of an LED lamp assembly according to an example embodiment of the present invention;

FIG. 3 is a perspective view of a socket housing according to an example embodiment of the present invention, depicting both a unitary socket housing and a two piece socket housing;

FIG. 4 is a perspective of a unitary socket housing according to an example embodiment of the present invention;

FIG. 5 is a front elevational view of a socket housing as depicted in FIG. 4;

FIG. 6 is a cross sectional view of a socket housing as depicted in FIG. 4;

FIG. 7 is a top view of a socket housing as depicted in FIG. 4;

FIG. 8 is a bottom elevational view of a socket housing according to FIG. 4;

FIG. 9 is a cross sectional view of an LED lamp assembly according to an example embodiment of the invention;

FIG. 10 is a perspective of the socket insert according to an example embodiment of the invention;

FIG. 11 is a top view of the socket insert of FIG. 10;

FIG. 12 is a side elevational view of the socket insert;

FIG. 13 is a front elevational view of the socket insert;

FIG. 14 is a bottom view of the socket insert;

FIG. 15 is a perspective view of a socket insert assembled with a two conductor wire according to an example embodiment of the invention;

FIG. 16 is a top view of the socket insert and two conductor wire of FIG. 15;

FIG. 17 is a bottom view of the socket insert and two conductor wire;

FIG. 18 is a front elevational view of the socket insert and two conductor wire;

FIG. 19 is a side elevational view of the socket insert and two conductor wire;

FIG. 20 is a perspective view of an LED lamp according to an example embodiment of the present invention;

FIG. 21 is a perspective view of the LED lamp with certain structure shown as transparent;

FIG. 22 is top plan view of the LED lamp;

FIG. 23 is bottom view of the LED lamp;

FIG. 24 is a rear elevational of the LED lamp;

FIG. 25 is side elevational view of the LED lamp;

FIG. 26 is a front elevational view of the LED lamp;

FIG. 27 is a perspective view of a cover according to an example embodiment of the present invention;

FIG. 28 is an elevational view of the cover of FIG. 27;

FIG. 29 is a top view of the cover;

FIG. 30 is a bottom view of the cover;

FIG. 31 depicts assembly of a two conductor wire to the socket insert;

FIG. 32 is a perspective depiction of the assembled wire and socket insert;

FIG. 33 is a perspective of a wire end socket insert being inserted into a socket housing;

FIG. 34 is a perspective view of an assembled socket housing with the insert and wire;

FIG. 35 is a perspective of an LED lamp being inserted into a socket housing;

FIG. 36 is a perspective of an assembled LED lamp in a socket housing depicting a short body LED lamp;

FIG. 37 is a phantom view of an assembled socket housing with LED lamp insert and wire;

FIG. 38 is a perspective view of a fully assembled LED lamp assembly according to an example embodiment of the invention;

FIG. 39 is a perspective exploded view of an LED lamp assembly according to an example embodiment of the invention;

FIG. 40 is a perspective exploded view of an LED lamp assembly according to an example embodiment of the invention with a socket housing partially cut away;

FIG. 41 is a perspective assembled view of an LED lamp assembly with the socket housing partially cut away;

FIG. 42 is a perspective view of a socket insert and a wire showing an assembly step;

FIG. 43 is a perspective view of an assembled socket insert and a wire;

FIG. 44 is a perspective view of a socket insert and wire being inserted into a socket housing according to an embodiment of the invention;

FIG. 45 is a perspective view of an assembled socket insert, wire and socket housing;

FIG. 46 is a perspective view of a LED lamp being inserted into a socket housing;

FIG. 47 is a perspective view of an assembled LED lamp and socket housing;

FIG. 48 is a plan view of a socket housing according to an example embodiment of the invention;

FIG. 49 is a bottom view of the socket housing of FIG. 48;

FIG. 50 is a cross sectional view of the socket housing of FIG. 48;

FIG. 51 is a perspective cut away view of the socket housing of FIG. 48;

FIG. 52 is a side elevational view of a socket insert according to an embodiment of the invention;

FIG. 53 is a plan view of the socket insert of FIG. 52 and

FIG. 54 is a front elevational view of the socket insert of FIG. 52.

### DETAILED DESCRIPTION OF THE DRAWINGS

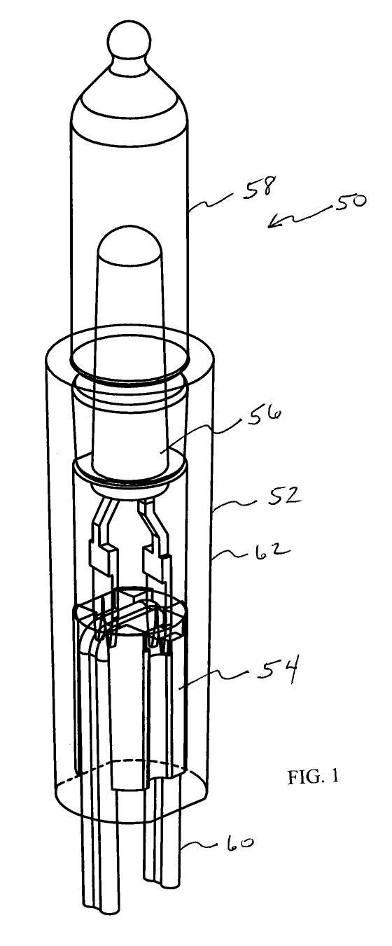

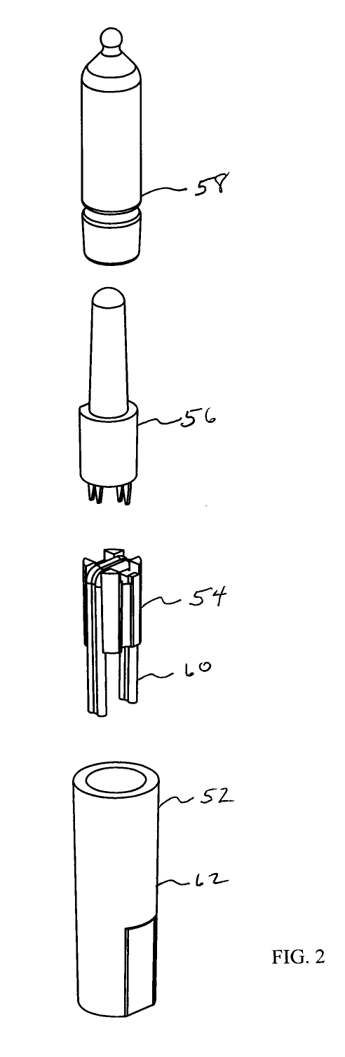

Referring to FIGS. 1 and 2, LED lamp assembly 50, according to an example embodiment of the invention, generally includes socket housing 52, socket insert 54, LED lamp 56, cover 58 and wire 60.

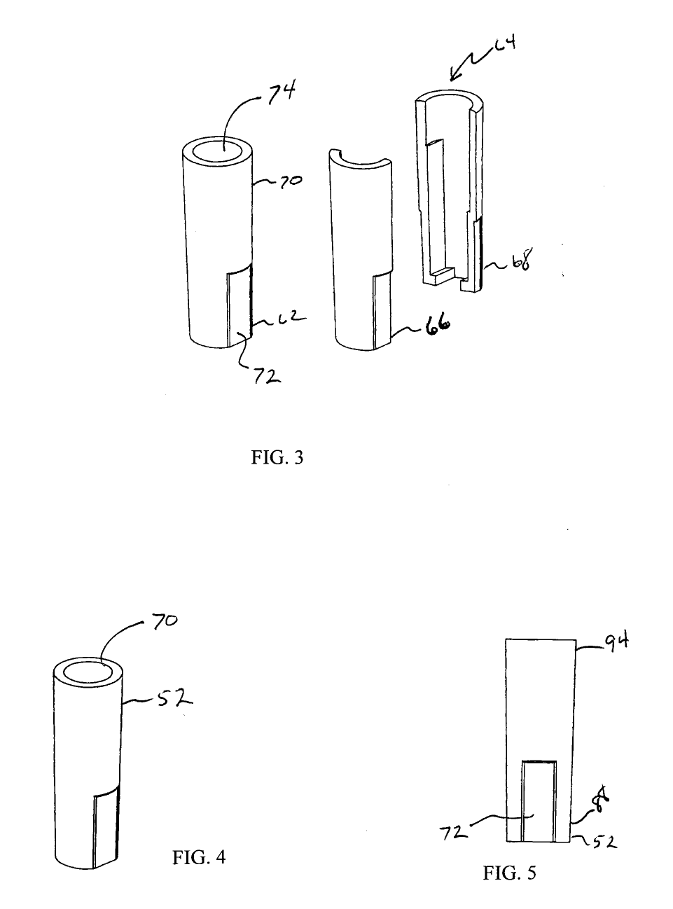

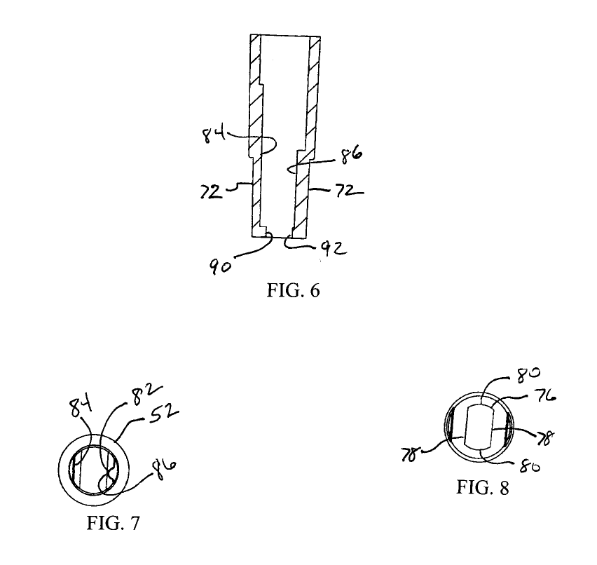

Referring particularly to FIGS. 3-8, socket housing 52 may be formed as a unitary housing 62 or a two piece housing 64. Two piece housing 64 generally includes first half 66 and second half 68.

Referring particularly to FIGS. 4-8, socket housing 52 includes generally cylindrical body 70. Cylindrical body 70 presents on an outside thereof, external flats 72, circular opening 74 on top thereof and elongate opening 76 on a bottom thereof.

Referring to FIG. 8, elongate opening 76 is defined by two opposed flat sides 78 and two opposed arcuate sides 80 defining the perimeter thereof.

Referring particularly to FIGS. 3, 6 and 7, interiorly socket housing 52 presents index structure 82 and internal flat 84 therein. Index structure 82 extends into the interior of socket housing 52 and is located generally opposed to internal flat 84. Index structure 82 may include, for example, index ridge 86.

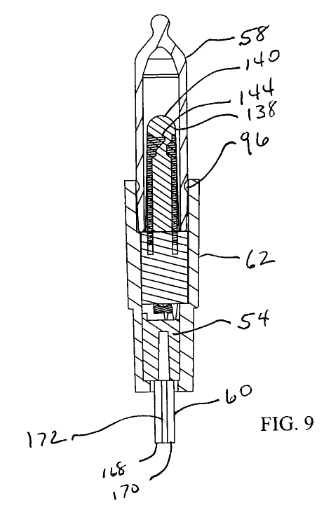

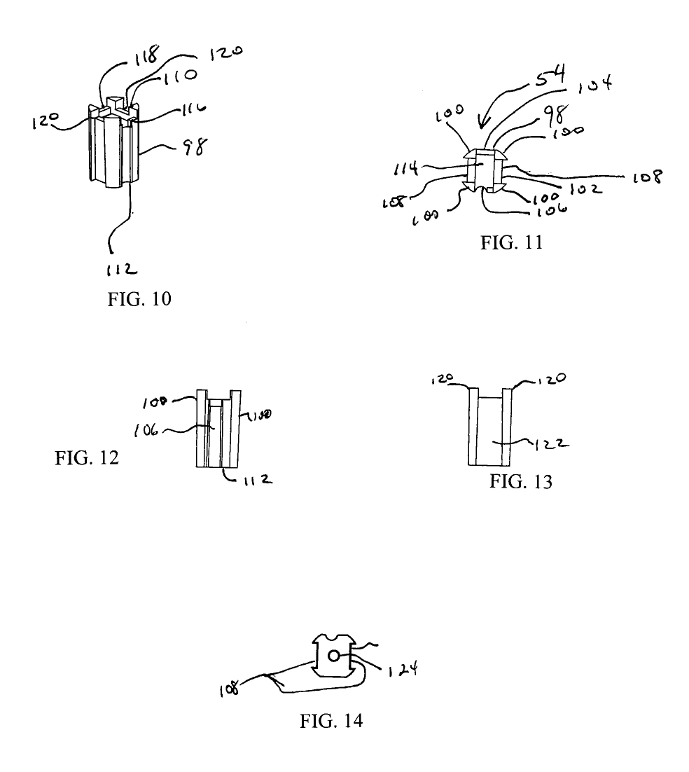

At a lower end 88 of socket housing 52 large step 90 and small step 92 are defined extending inwardly. Large step 90 and small step 92 are generally opposed and form flat sides 78 of elongate opening 76. As best seen in FIG. 9, at upper end 94 of socket housing 52, annular ridge 96 is defined surrounding circular opening 74.

While socket housing 52 is generally cylindrical in shape it may be slightly tapered from one end to the other. Socket housing 52 is formed of a generally non-conductive material, typically a polymer.

Referring particularly to FIGS. 11-19, socket insert 54, in this example embodiment, is a unitary structure formed of a non-conductive material. Socket insert 54 generally includes non-conductive body 98. Non-conductive body 98 generally includes corner structures 100 surrounding central core 102. Non-conductive body 98 presents flat side 104 generally opposing indexed side 106. Wire receiving sides 108 are located perpendicular to flat side 104 and indexed side 106. Non-conductive body 98 also presents top 110 and generally flat bottom 112. Top 110 generally presents top cavity 114 bordered by index wall 116, opposing flat wall 118 and two wire side walls 120 generally opposed to each other. Wire receiving sides 108 generally define wire receiving grooves 122 between corner structures 100.

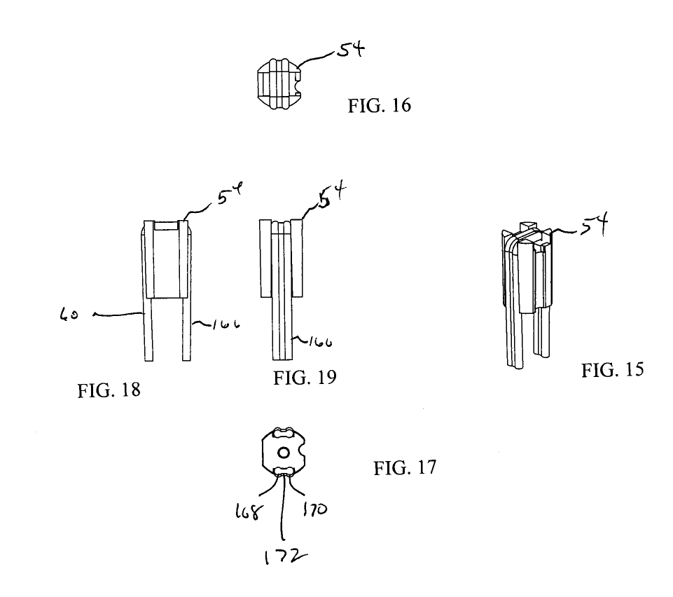

Referring to FIGS. 14 and 17, central core 102 may define central hole 124 therein. FIGS. 15-19 depict socket insert 54 assembled with wire 60.

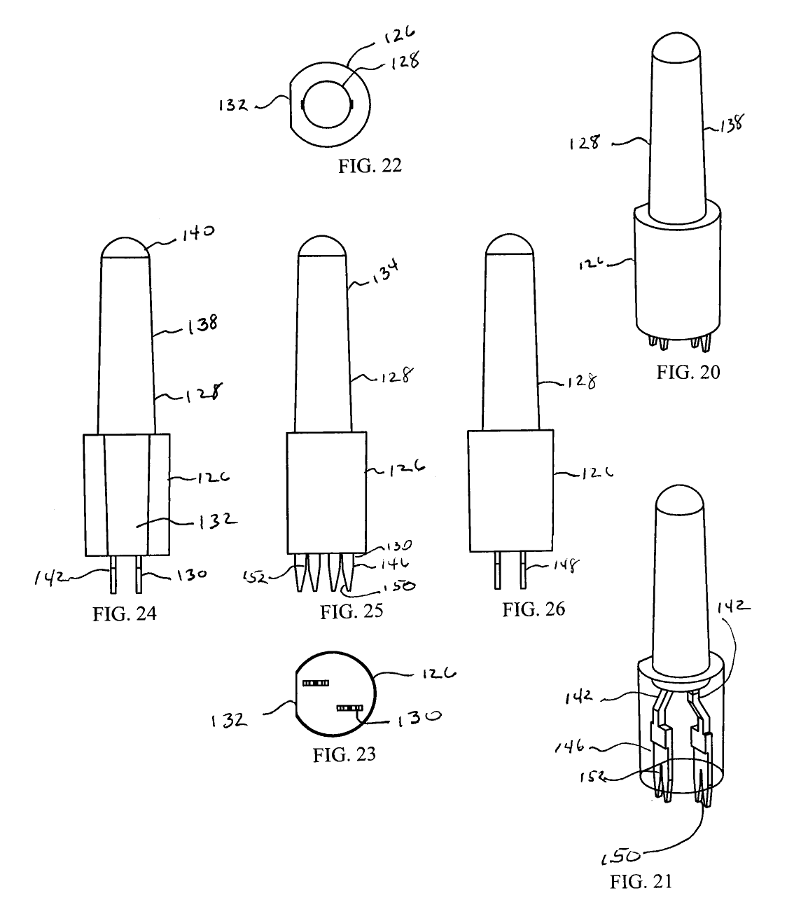

Referring particularly to FIGS. 20-26, LED lamp 56 generally includes base 126, lens 128 and lead frame 130.

Base 126 is generally cylindrical in shape and presents indexing flat 132.

Lens 128 may be long or short as depicted in FIGS. 36 and 37. Long lens 134 is depicted in FIG. 37 while short lens 136 is depicted in FIG. 36. Lens 128 is transparent or translucent and generally formed of a polymer material though other materials may be used.

Referring particularly to FIGS. 20, 21 and 24-26, lens 128, as depicted, presents tapered portion 138 and dome 140.

Lead frame 130 generally includes wire piercing conductors 142. According to an example embodiment of the present invention, wire piercing conductors 142 extend upwardly to LED chip 144 and downwardly to form wire piercing portions 146. Wire piercing conductors 142 are electrically coupled to LED chip 144.

Referring particularly to FIGS. 21 and 25, in one example embodiment, wire piercing portion 146 includes fork portion 148 defining funnel shaped entrance 150 and wire receiving slot 152. Fork portions 148 of two wire piercing conductors 142 may be staggered in position as is particularly well seen in FIGS. 21 and 23.

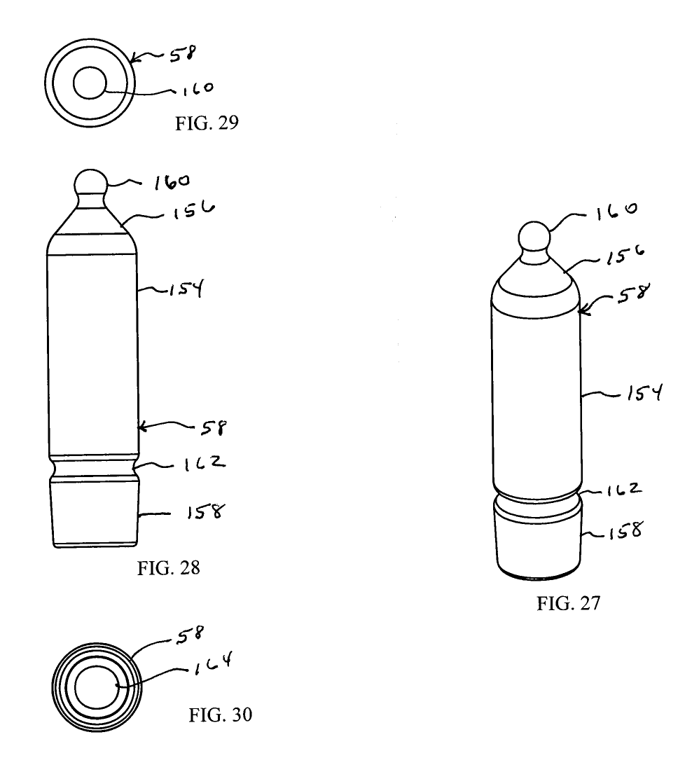

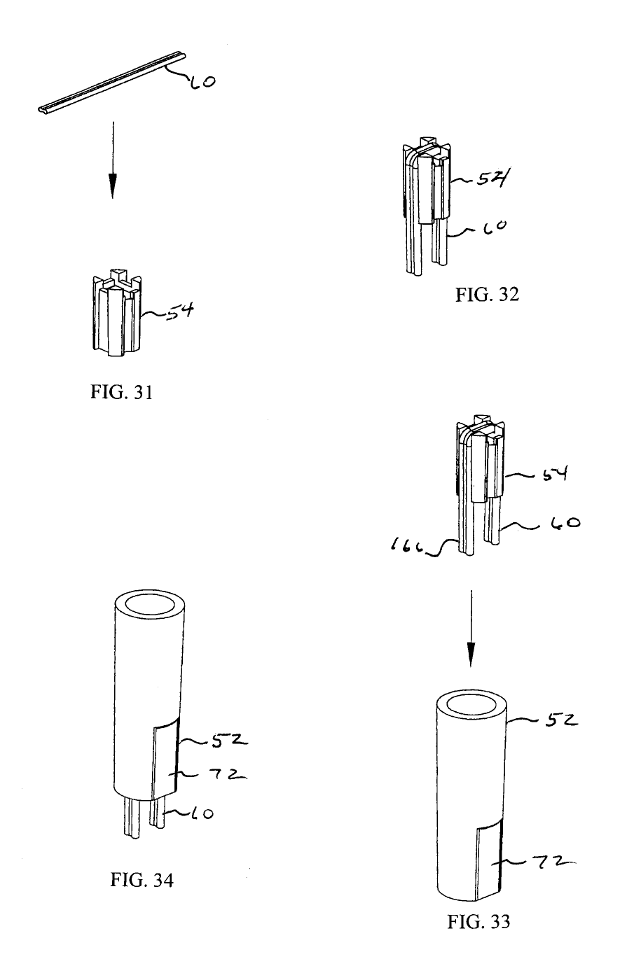

Referring particularly to FIGS. 27-30, cover 58 is a generally transparent or translucent structure formed of, for example, a polymer. Cover 58 includes cylindrical portion 154, conical portion 156, tapered portion 158, knob 160 and annular groove 162. Cover 58 generally has the appearance of an incandescent mini light of a design that is familiar to many people. Annular groove 162 is dimensioned to engage annular ridge 96. Cover 58 also defines interior cavity 164.

Wire 60 is generally a two conductor wire 166 of conventional design. Two conductor wire 166 generally includes first conductor 168 and second conductor 170 which are generally parallel oriented to one another. Two conductor wire 166 also presents insulation 172 surrounding and separating first conductor 168 and second conductor 170.

The present invention also includes a method of assembly of an LED lamp assembly 50. Assembly of LED lamp assembly 50 includes inserting a loop of wire 60 through socket housing 52 from below into elongate opening 76 and through socket housing 52 so that loop of wire 60 extends out of circular opening 74.

Two conductor wire 166 is then engaged to socket insert 54 as depicted in FIGS. 33 and 15-19. Thus, two conductor wire 166 passes over wire receiving sides 108 of socket insert 54 so that two conductor wire 166 is engaged in wire receiving grooves 122 and passes over wire sidewalls 120. A portion of two conductor wire 166 thus overlies top cavity 144 and is supported by wire sidewalls 120 on each side of top cavity 144.

Two conductor wire 166 is then drawn downward as depicted in FIG. 33, thus drawing socket insert 54 into socket housing 52. Socket insert 54 is oriented so that internal flat 84 of socket housing 54 engages flat side 104 of socket insert 54. Similarly, index side 106 of socket insert 54 engages index ridge 86 of index structure 82 of socket housing 52 thus assuring proper orientation of socket insert 54 relative to socket housing 52. Socket insert 54 is moved downward into socket housing 52 until bottom 112 of socket insert 54 engages large step 90 and small step 92 adjacent elongate opening 76. Thus, socket insert 54 is fully engaged in socket housing 52 securing two conductor wire 166 therein while two conductor wire 166 extends out of elongate opening 76.

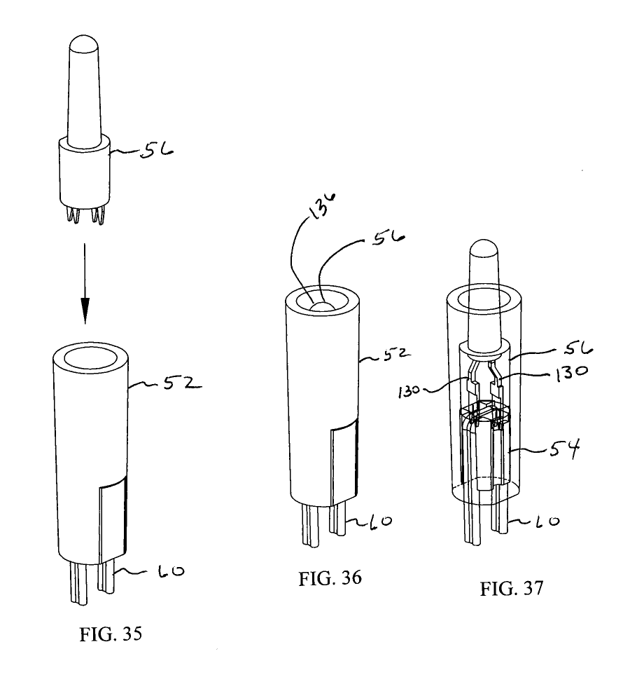

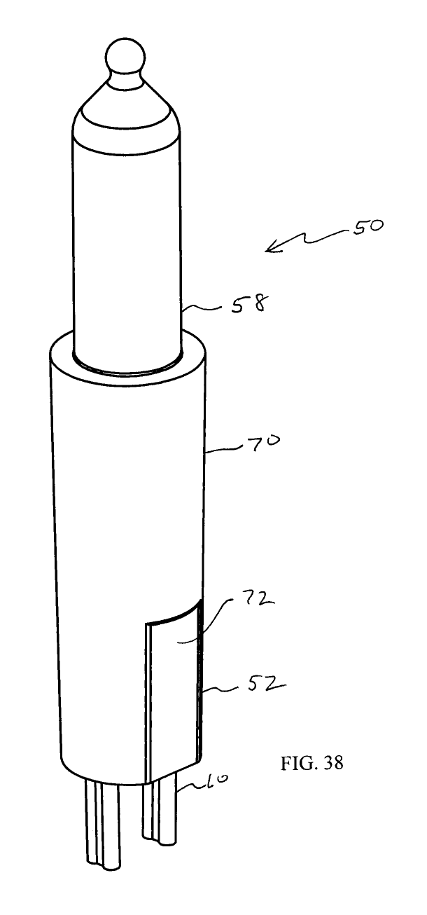

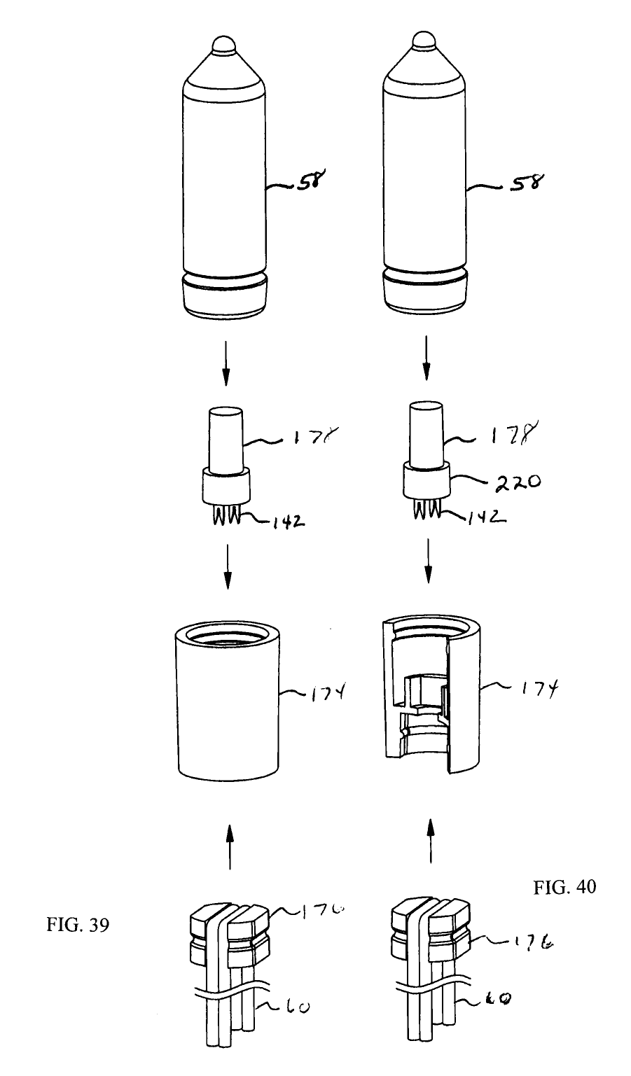

Referring particularly to FIGS. 35-37, LED lamp 56 is then inserted into socket housing 52 through circular opening 74. Indexing flat 132 of base 126 of LED lamp 56 aligns with internal flat 84 of socket housing 52 thus assuring desired orientation of LED lamp 56 relative to socket housing 52 and socket insert 54.

As best seen in FIGS. 1, 9 and 37, when indexing flat 132 abuts internal flat 84 wire piercing portion 146 of wire piercing conductors 142 are aligned to engage first conductor 168 and second conductor 170 of two conductor wire 166. First conductor 168 is engaged via funnel shaped entrance 150 until first conductor 168 is engaged in wire receiving slot 152 of one of wire piercing portion 146. Second conductor 170 is engaged by funnel shaped entrance 150 of the other wire piercing conductor 142 and forced into wire receiving slot 152. The dimensions of wire receiving slot 152 and first conductor 168 and second conductor 170 are chosen so that first conductor 168 and second conductor 170 are received in wire receiving slot 152 in a tightly fitting relationship excluding all air from the junction where wire receiving slots 152 and first conductor 168 and second conductor meet.

As can be seen in FIGS. 36 and 37, lens 128 of LED lamp 156 may be long as depicted in FIG. 37 or short as depicted in FIG. 36 thus long lens 134 will extend upwardly into interior cavity 164 of cover 58 when cover 58 is inserted into socket housing 52. Short lens 136 will extend into interior cavity 164 to a lesser degree.

Cover 58 is then placed into socket housing 52 and advanced until annular ridge 96 of socket housing 52 engages annular groove 162 of cover 58.

LED lamp assembly 50 is then assembled.

In another embodiment of the present invention, a plurality of LED lamp assemblies 50 are arranged along a length of two conductor wire 166 spaced apart and in sequence to create a decorative light string made-up of LED lamp assemblies 50. In an embodiment, the decorative light string comprises a power plug for plugging into an electrical outlet of a power source, a length of two-conductor wire 60, a first end of the two-conductor wire in electrical connection with the power plug; and a plurality of LED lamp assemblies 50 spaced apart along the length of two-conductor wire 60. In an embodiment, the plurality of LED lamps are electrically connected in parallel. In another embodiment, the plurality of LED lamps are electrically connected in series. In some such embodiments, a series connection may be attained using a wire 60 having conductive gaps such that portions of a conductor of wire 60 may not be contiguous.

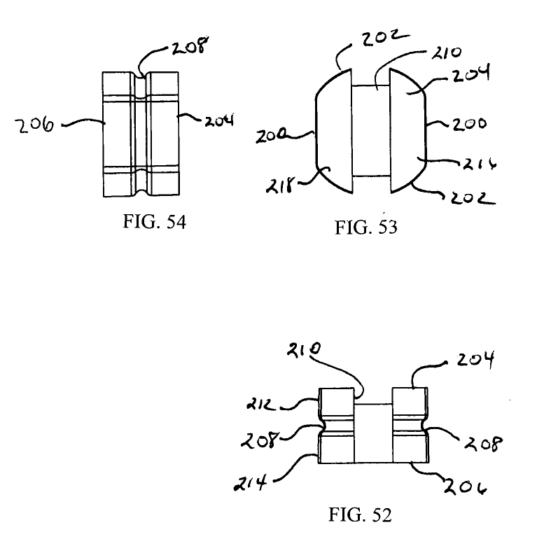

Another embodiment of the invention is depicted in FIGS. 39-54. Referring particularly to FIGS. 39 and 40, in this embodiment LED Lamp Assembly 50 generally includes socket housing 174, socket insert 176, LED lamp 178, cover 58 and wire 60. In this embodiment, cover 58 and wire 60 are similar to those described above and will not be described again here.

Socket housing 174, particularly as depicted in FIGS. 39-41 and 49-51 is externally generally cylindrical in structure, though in some embodiments, socket housing 174 may be somewhat tapered, have a larger diameter top portion as compared to a bottom portion. Cylindrical body 180 generally defines circular opening 182 and elongate opening 184 at opposite ends thereof.

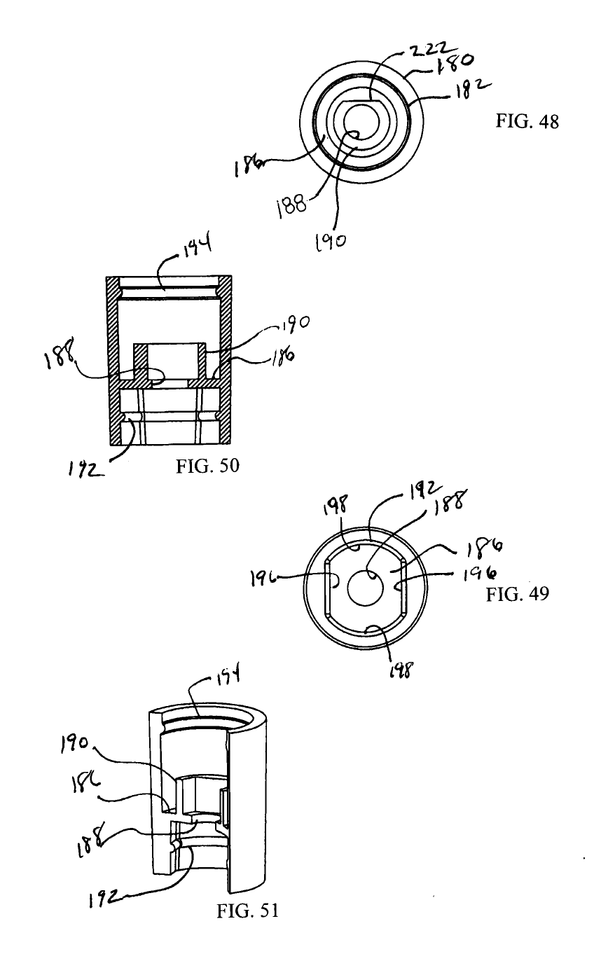

Referring particularly to FIGS. 48-51, according to one example embodiment, internally, socket housing 174 is divided by annular wall 186. Annular wall 186 defines central opening 188 therethrough. As depicted, annular wall 186 also supports cylindrical wall 190 thereon. Cylindrical wall 190 is positioned generally concentrically within cylindrical body 180 and surrounds central opening 188 on one side of annular wall 186. These structures may be unitarily formed.

Referring particularly to FIGS. 50-51, socket housing 174 also presents circumferential insert ridge 192 extending annularly around the internal perimeter of cylindrical body 180 near elongate opening 184.

Referring particularly to FIG. 49, elongate opening 184 presents and is bounded by flat sides 196 and arcuate sides 198.

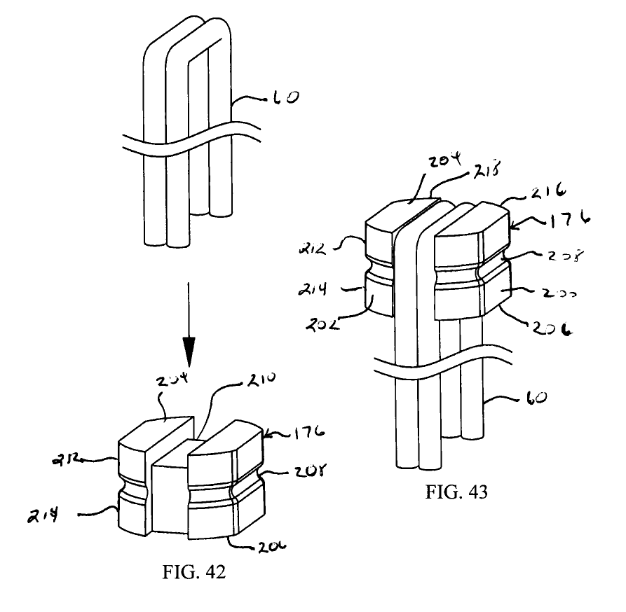

Referring particularly to FIGS. 42 and 52-54, socket insert 176, in the depicted example embodiment, generally presents flat wall 200, arcuate walls 202, top 204 and bottom 206. Socket insert 176 also defines circumferential groove 208 passing around flat walls 200 and arcuate walls 202 generally between top 204 and bottom 206.

In addition, socket insert 176 defines wire groove 210. Wire groove 210 is bordered by portions of top 204 and two arcuate walls 202. Circumferential groove 208 is bordered by upper portion 212 and lower portion 214. Wire groove 210 is bounded by front portion 216 and back portion 218. Socket insert 176 may be formed of a resilient polymer material. Socket housing 174 may be formed of a similar polymer material or the same polymer material as socket insert 176.

Referring to FIGS. 39-40, LED lamp 178 is generally similar to that described above and includes base 126, lens 128 and lead frame 130. Base 126 of LED lamp 178 presents orientation flat 220 and is dimensioned generally to fit within cylindrical wall 190 which presents complementary flat 222. Cover 58 and wire 60 of the embodiment depicted is generally similar to that described above and need not be further described here.

Referring particularly to FIGS. 42 and 43, to assemble the depicted embodiment, wire 60 is passed over socket insert 176 so that wire 60 is located in wire groove 210. Wire 60 extends up one side of wire groove 210, across top 204 of socket insert 176 and down an opposing side of socket insert 176 in wire groove 210. Thus, wire 60 is bounded by front portion 216 and back portion 218 of socket insert 176. Socket insert 176 and wire 60 are then inserted into socket housing 174 through elongate opening 184.

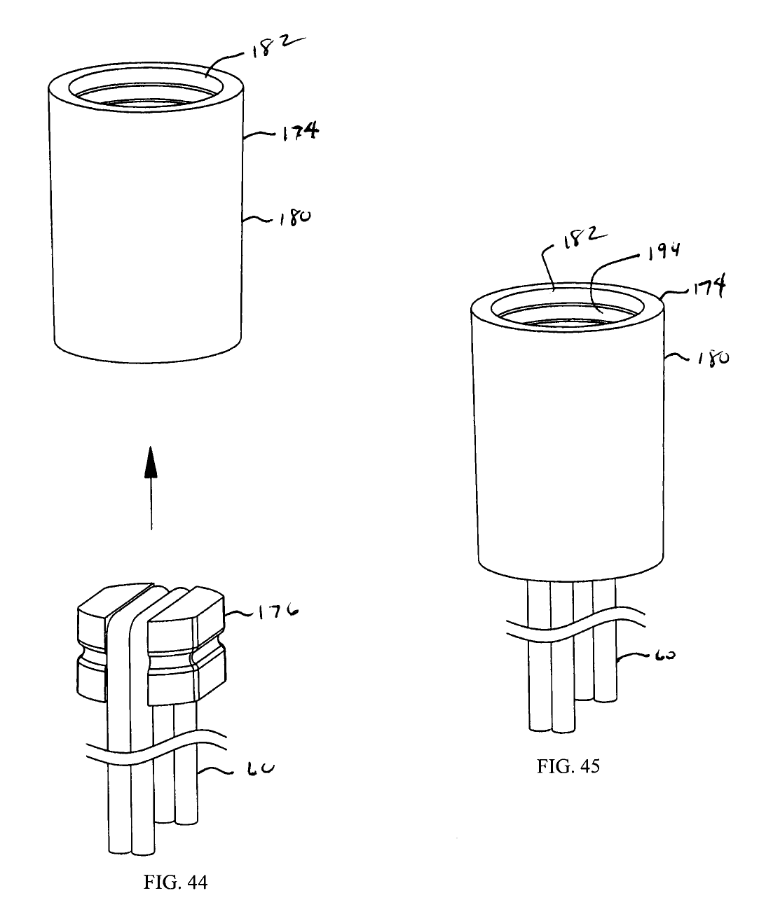

Referring to FIGS. 44 and 45, flat wall 200 of socket insert 176 is aligned with flat sides 196 of elongate opening 184. Arcuate walls 202 of socket insert 176 are aligned with arcuate sides 198 of elongate opening 184. Socket insert 176 is then secured within socket housing 174 by the engagement of circumferential insert ridge 192 into circumferential groove 208. Thus, socket insert 176 is forced into socket housing 174 and engaged by the resiliency of socket housing 174 and socket insert 176.

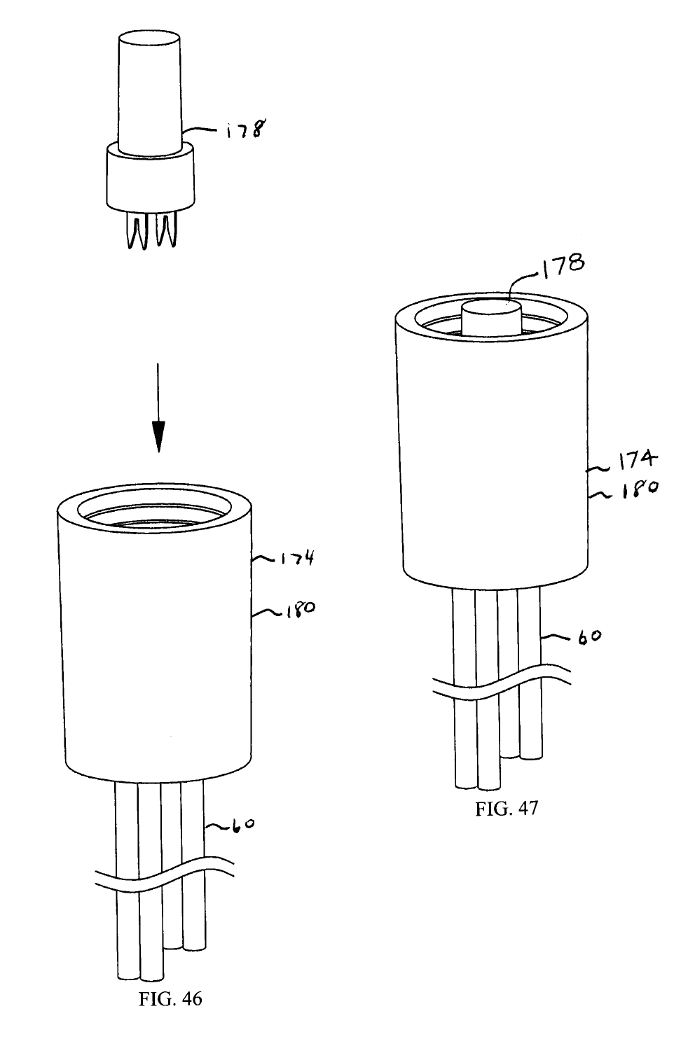

Next as depicted in FIGS. 46 and 47, LED lamp 56 is inserted into socket housing 174 so that base 126 is received within cylindrical wall 190. Wire piercing conductors 142 then extend through central opening 188 of socket housing 174. As depicted in FIGS. 48 and 51, orientation flat 220 is aligned within complimentary flat 222 within cylindrical wall 190.

As best seen in FIGS. 39-41, wire piercing conductors 142 then extend downward to pierce wire 60 as it lies within wire groove 210. This establishes a secure electrical connection between wire piercing conductors 142 and first conductor 168 and second conductor 170 of wire 60.

Cover 58 is then inserted into circular opening 182. As cover 58 is forced into circular opening 182, annular cover ridge 194 engages annular groove 162 thus securing cover 58 to socket housing 174 because of the resiliency of the material from which socket housing 174 is formed.

In another embodiment, referring to FIGS. 39-40 and 42-47, the invention also includes a method of assembling LED lamp assembly 50. The method includes placing wire 60 into wire groove 210 such that wire 60 is seated in wire groove 210. Then, assembled wire 60 and socket insert 176 are inserted into socket housing 174 through elongate opening 184 until circumferential insert ridge 192 is fully engaged into circumferential groove 208 of socket insert 176. Wire 60 is then pressed against annular wall 186 and aligned with central opening 188 if annular wall 186 and central opening 188 are present.

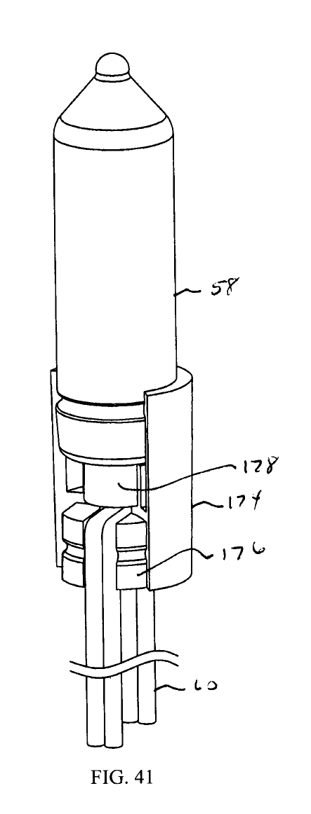

Referring to FIGS. 41, 46 and 47, LED lamp 178 is then inserted into socket housing 174. Wire piercing conductors 146 pierce insulation 172 and establish electrical contact with first conductor 168 and second conductor 170. Base 126 of LED lamp 178 is received within cylindrical wall 190 and orientation flat 220 is received adjacent to complementary flat 222.

Referring to FIGS. 39-41, cover 58 is inserted into circular opening 182 until annular cover ridge 194 engages annular groove 162. This embodiment of LED lamp assembly 50 is then fully assembled.

In operation, once assembled as discussed above, electrical current is applied at two conductor wire 166 thus supplying electrical current in parallel to LED lamps 56 within LED lamp assemblies 50 thus illuminating LED chips 144 providing a pleasing illuminated appearance. LED chips 144 may be made to be of similar colors or many different colors to provide a festive appearance to a plurality of LED lamp assemblies 50.

The present invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

1. An LED lamp assembly, comprising:
a generally cylindrical socket housing;
a socket insert receivable into the socket housing and keyed to the socket housing to be receivable into the housing in a selected orientation;
a two conductor wire having two insulated conductors surrounded by insulation and engaged over the socket insert on two sides and a top of the socket insert and interposed between the socket insert and an interior of the socket housing and extending out of a bottom of the socket housing; and
an LED lamp including a base, a lens and two wire piercing conductors insertable through a top of the socket housing, each of the two wire piercing conductors piercing the insulation and engaging one of the two insulated conductors and the base including an orientation structure that engages the socket housing such that the two wire piercing conductors are aligned with the two insulated conductors when the socket insert and the LED lamp are inserted into the socket housing.

2. The LED lamp assembly as claimed in claim 1, further comprising a light transmitting cover secured over the lens of the LED lamp.

3. The LED lamp assembly as claimed in claim 1, wherein at least one of the two wire piercing conductors further comprises a wire receiving portion.

4. The LED lamp assembly as claimed in claim 3, wherein the wire receiving portion further comprises a forked portion that receives one of the two conductors therein.

5. The LED lamp assembly as claimed in claim 4, wherein the forked portion defines a funnel shaped entrance and a wire receiving slot, the wire receiving slot being dimensioned to receive the one of the two conductors therein in close fitting apposition.

6. The LED lamp assembly as claimed in claim 1, wherein the socket housing is a unitary structure formed as a single piece.

7. The LED lamp assembly as claimed in claim 1, wherein the socket insert further comprises a central core presenting four corner structures.

8. The LED lamp assembly as claimed in claim 1, wherein the socket insert comprises a generally flat side and an opposing indexed side.

9. The LED lamp assembly as claimed in claim 7, wherein the socket insert comprises a top having two wire side walls, an indexed wall and a flat wall surrounding a top cavity, the top cavity being positioned and shaped to receive the two wire piercing conductors therein.

10. The LED lamp assembly as claimed in claim 1, wherein the socket insert presents an arcuate wall and at least one flat wall whereby the socket insert is keyed to the socket housing.

11. The LED lamp assembly as claimed in claim 1, wherein the socket insert presents a first circumferential engagement structure and the socket housing presents a complementary second circumferential engagement structure that are structured to mutually engage and secure the socket insert within the socket housing.

12. The LED lamp assembly as claimed in claim 1, wherein the socket insert is insertable into the socket housing through the top of the socket housing.

13. The LED lamp assembly as claimed in claim 1, wherein the socket insert is insertable into the socket housing through the bottom of the socket housing.

14. The LED lamp assembly as claimed in claim 2, wherein the LED lens extends upwardly into an internal cavity of the light transmitting cover.

15. A method of assembling an LED lamp assembly, the method comprising:
inserting a socket insert into a loop of two conductor wire such that the two conductor wire passes up a first side of the socket insert, across a top of the socket insert and down a second side of the socket insert;
inserting the loop of two conductor wire and the socket insert into a generally cylindrical socket housing until the socket insert abuts an interior structure of the socket housing that secures the socket insert and the loop of two conductor wire within the socket housing; and
inserting an LED lamp into the socket housing such that each of two wire piercing conductors pierce insulation of the two conductor wire and establish conductive electrical connection with one of the two conductors of the two conductor wire.

16. The method as claimed in claim 15, further comprising inserting the loop of the two conductor wire through the generally cylindrical socket housing into an opening at a bottom of the socket housing and extending the loop of two conductor wire out of an opening at a top of the socket housing prior to inserting the socket insert into the loop of the two conductor wire.

17. The method as claimed in claim 15, further comprising inserting the socket insert into the generally cylindrical socket housing through the opening at the top of the socket housing after inserting the socket insert into the loop of the two conductor wire.

18. The method as claimed in claim 15, further comprising aligning an indexed portion of the socket insert with an index structure of the socket housing prior to inserting the socket insert into the socket housing.

19. The method as claimed in claim 15, further comprising securing a light transmitting cover over a lens of the LED lamp.

20. The method as claimed in claim 15, further comprising aligning an indexing portion of the LED lamp with an indexed portion of the socket insert prior to inserting the Led lamp into the socket housing.

21. The method as claimed in claim 15, further comprising engaging a wire receiving portion of the wire piercing conductors to the conductors of the two conductor wire.

22. The method as claimed in claim 17, further comprising selecting the LED lamp such that the lens extends into an interior cavity of the cover when the cover is secured over the lens of the LED lamp.

23. The method as claimed in claim 15, further comprising passing a funnel shaped entrance of the wire piercing conductor over the conductor of the two conductor wire and guiding the conductor of the two conductor wire into a wire receiving slot of the wire piercing conductor.

24. The method as claimed in claim 15, further comprising:
inserting a second socket insert into a second loop of the two conductor wire such that the second loop of the two conductor wire passes up a first side of the second socket insert, across a top of the second socket insert and down a second side of the second socket insert;
inserting the second loop of the two conductor wire and the second socket insert into a second cylindrical socket housing until the second socket insert abuts an interior structure of the second socket housing that secures the second socket insert and the second loop of two conductor wire within the second socket housing;
inserting a second LED lamp into the second socket housing such that each of second two wire piercing conductors pierce the insulation of the second loop of two conductor wire and establish conductive electrical connection with one of the two conductors of the two conductor wire of the second loop.

25. An LED lamp assembly, comprising:
a socket housing;
a socket insert receivable into the socket housing and keyed to the socket housing to be receivable into the housing in a selected orientation;
an insulated wire having two wire conductors surrounded by insulation and engaged with the socket insert interposed between the socket insert and an interior of the socket housing and extending out of the socket housing; and
an LED lamp including a base, a lens and two lamp conductors insertable through a top of the socket housing, each of the two lamp conductors engaging one of the two wire conductors and the base including an orientation structure that engages the socket housing such that the two conductors are aligned with the two wire conductors when the socket insert and the LED lamp are inserted into the socket housing.

26. The LED lamp assembly of claim 25, wherein the socket housing includes an internal annular wall contacting a top surface of the socket insert and a top surface of each of the two wire conductors.

27. The LED lamp assembly of claim 26, wherein the orientation structure of the socket housing includes a cylindrical wall supported by the internal annular wall.

28. The LED lamp assembly of claim 26, wherein the two wire conductors are side-by-side wire conductors.

29. A decorative light string, comprising:
a power plug for plugging into an electrical outlet of a power source;
a length of two-conductor wire, a first end of the two-conductor wire in electrical connection with the power plug; and
a plurality of LED lamp assemblies spaced apart along the length of two-conductor wire, each LED lamp assembly including:
a generally cylindrical socket housing;
a socket insert receivable into the socket housing and keyed to the socket housing to be receivable into the housing in a selected orientation;
a portion of the two conductor wire engaged over the socket insert on two sides and a top of the socket insert and interposed between the socket insert and an interior of the socket housing and extending out of a bottom of the socket housing; and
an LED lamp including a base, a lens and two lamp conductors, each of the two lamp conductors in electrical contact with one of two conductors of the two-conductor wire, and the base including an orientation structure that engages the socket housing such that the two lamp conductors are aligned with the two conductors of the two-conductor wire when the socket insert and the LED lamp are inserted into the socket housing.

30. The decorative light string of claim 29, wherein the plurality of LED lamps are electrically connected in parallel.

31. The decorative light string of claim 29, wherein the plurality of LED lamps are electrically connected in series.
